(19) United States
(12) Patent Application Publication
(10) Pub. No.: US 2026/0312816 A1
(43) Pub. Date: Oct. 8, 2026

(54) METHOD FOR GENERATING A CODE, METHOD FOR VERIFYING A CODE, DOCUMENT COMPRISING THE CODE, AND USE OF THE CODE

(71) Applicant: KURZ Digital Solutions GmbH & Co. KG, Fürth (DE)

(72) Inventors: Alexander MANZER, Fürth (DE); Benno SCHMITZER, Fürth (DE)

(21) Appl. No.: 19/482,870

(22) PCT Filed: May 17, 2024
(86) PCT No.: PCT/EP2024/063719

§ 371 Date: Nov. 10, 2025

(30) Foreign Application Priority Data
May 22, 2023 (DE) 10 2023 113 266.0

(51) Int. Cl. H04L 9/32; H04L 9/08

(52) U.S. Cl. CPC H04L 9/3231; H04L 9/0866; H04L 9/3239; H04L 9/3252

(57) ABSTRACT

A method for generating a code 3 based on first biometric characteristics 2′, to a method for verifying a code 3, to a document 4 comprising the code 3, and to the use of the code 3.

The invention relates to a method for generating a code based on first biometric characteristics, to a method for verifying a code, to a document comprising the code, and to the use of the code.

It is known that graphical machine-readable codes are used to store information items and enable these to be read using a terminal device. Such codes offer the advantage that they can be easily created, and read by devices even without a high level of computing power. The information items comprised by the codes are therefore quickly and easily available.

The volume of information that can be stored in the code is however limited. Here, the volume of information that can be stored in the code is dependent on the size of the code, for example on a document. The available space, for example on the document, limits the size of the code and thus the volume of information. The field of use of these codes is therefore limited to simple applications, such as the storage of an Internet address or other simple alphanumeric information items of relatively small volume. Here, the size of the code or the available space is to be understood to mean a two-dimensional graphical image size or two-dimensional dimension, in particular a two-dimensional print or a two-dimensional image on a substrate, for example on a document, wherein the code components, in particular the modules, must have a minimum two-dimensional size or minimum two-dimensional dimension in order to provide the desired machine readability.

Personal data can be relatively complex. Relatively complex personal data are biometric data such as biometric characteristics. Since these are difficult to tamper with, they lend themselves to use for the identification of people, but they require more storage capacity owing to their complexity.

If relatively large volumes or relatively complex volumes of personal data relating to a person are to be stored in order to ensure reliable verification and authenticity of a document, the storage capacity of a graphical machine-readable code, for example a 1D barcode or a QR code, is easily exceeded. At present, use is therefore made of memory chips on which personal data are stored and which are embedded into the document to be verified. Memory chips are however much more complicated to produce and comprise more expensive materials the machine-readable graphical codes. Furthermore, the recycling of these materials also constitutes a challenge.

There is therefore no practical solution for inexpensively and reliably making biometric data, such as biometric characteristics, available such that they can be straightforwardly verified using simple electronic devices. Furthermore, there is presently no standard specification for machine-readable graphical codes based on biometric data.

It is an object of the invention to provide an improved code for verification of a document, wherein the code is in the form of a geometrical pattern and is based on biometric characteristics.

The object is achieved by means of a method, in particular by means of a method according to claim 1, for generating a code which is based on first biometric characteristics, wherein the method comprises at least the following steps:
a) capturing at least one biometric information item from a real person, a photograph and/or a video,
b) extracting first biometric characteristics from the at least one biometric information item, in particular by means of a neural network, in the form of a first data set,
c) compressing the first data set to obtain a compressed first data set,
d) adding a second data set comprising useful data to the compressed first data set,
e) generating a first hash value of the compressed first data set or of the compressed first data set and the second data set,
f) generating a signature for the first hash value,
g) generating the code in the form of a geometrical pattern comprising the first compressed data set, which is based on the first biometric characteristics, and comprising the first hash value and the signature.

Preferred embodiments of the method according to claim 1 are described in the dependent claims 2 to 24.

The object is also achieved by means of a method, preferably by means of a method according to claim 25, for verifying a code, in particular a code according to claim 1, wherein the method comprises at least one of the following steps A) or B):
A) creating a compressed third data set, wherein the compressed third data set is based on second biometric characteristics, wherein step A) comprises at least the following sub-steps:
   capturing at least one biometric information item of a real person, a photograph or a video,
   extracting second biometric characteristics, in particular by means of a neural network, from the at least one biometric information item in the form of a third data set,
   compressing the third data set to obtain a compressed third data set, or
B) opening a database which comprises at least one compressed third data set, wherein the compressed third data set is based on second biometric characteristics,
wherein the method also comprises at least the following steps:
   h) reading out a compressed first data set from the code, wherein the compressed first data set is based on first biometric characteristics, and comparing the compressed first data set with the compressed third data set,
   i) generating an evaluation parameter that allows the evaluation of a correspondence of the compressed first data set with the compressed third data set,
   j) outputting an evaluation on the basis of the generated evaluation parameter.

Preferred embodiments of the method according to claim 25 are described in the dependent claims 26 to 31.

The object is also achieved by means of a document, in particular a document according to claim 32, which comprises a code generated according to claim 1.

Preferred embodiments of the document according to claim 32 are described in the dependent claims 33 to 39.

The object is also achieved by means of the use, in particular by means of the use according to claim 40, of the code generated according to claim 1 in a document, wherein the document is selected from the group consisting of certificate, deed, ticket, preferably flight ticket, rail ticket, event ticket, concert ticket, conference ticket, entry ticket, an access control document, an official document, preferably visa, residence permit, proof of arrival, temporary identity document, residence title or combinations thereof.

The present invention makes it possible to combine biometric information items, preferably biometric characteristics, with machine-readable graphical codes. In this way, an object, for example a document, can be linked to a person, which is one of the main objectives in the case of documents issued by authorities or organizations. Since the generation of a code in the form of graphical patterns requires negligible additional material outlay, it is possible for biometric information items, preferably biometric characteristics, to be incorporated into documents inexpensively. It is additionally possible for the information items, preferably biometric characteristics, to be easily checked using simple devices, for example using conventional smartphones. It can nevertheless be ensured by means of the invention that the stored information items, preferably biometric characteristics, are securely protected, on the basis of asymmetric cryptography, against forgery or tampering.

Further advantageous refinements of the invention are indicated in the dependent claims.

In step a), at least one biometric information item is detected. Step a) is preferably the first step of the method for creating the code, and is carried out before step b).

Biometric information is preferably to be understood to mean the physiological form of a body or of a body part. Of interest are biometric information items which occur in all people in a group to be distinguished but which are individual to each particular person. Preferably, the biometric information items are unique to a person, are independent of age or a time of measurement, can be captured by way of a defined measurement variable or measurement method, and can be captured substantially for all people.

Preferably, at least the biometric information item of a face, a fingerprint, the palm veins, and/or an eye, preferably an iris and/or a retina, is captured. The biometric information item of a face is particularly preferably captured.

It is possible that the at least one biometric information item is in two-dimensional and/or three-dimensional form, and/or that the at least one biometric information item is captured in two-dimensional and/or three-dimensional form.

Parts or forms of at least one biometric information item which are characteristic of a particular person, in particular allow a distinction with respect to other people, are to be understood as biometric characteristics. They are unique to a particular person in relation to a group of people that is to be distinguished. Biometric characteristics are preferably comprised by or obtained from at least one biometric information item. The biometric characteristics are preferably dependent on the physiology of a person. Biometric characteristics that are captured for the purposes of generating the code may be referred to as first biometric characteristics. Biometric characteristics that are additionally captured for the purposes of verifying the code may be referred to as second biometric characteristics. If the first and second biometric characteristics of the same person are captured, then the second biometric characteristics may correspond to, or may entirely or partially comprise, the first biometric characteristics. In particular, the second biometric characteristics have the same embodiments as for the first biometric characteristics of the first data set. This allows the compressed first data set to be compared with the compressed third data set.

It is possible that the at least one biometric information item is captured by means of a device selected from the group: smartphone, camera, tablet, PC, terminal, IoT devices or combinations thereof. The device has at least one apparatus for capturing images, and has a processor for carrying out at least one further step of the method.

This offers the advantage that there is no need to use expensive specialist devices, and the method can instead be carried out even using common devices.

It is possible that the device is a client device, and the at least one biometric information item is transmitted via a network to an external server, on which one or more or all of the subsequent steps are carried out.

It is alternatively possible that all of the steps of the method are carried out locally on the device, preferably without a network connection, in particular wireless network connection, to an external server.

In step b), first biometric characteristics are extracted, in particular identified and extracted, from at least one biometric information item. Step b) is preferably carried out after step a) and before step c).

It is possible that one or more biometric characteristics, in particular the first and/or second biometric characteristics, are selected from the group consisting of tip of the nose, corner of the eye, eyebrow, tip of the chin, center of the nose, center of the eyes, contour of the eyes, contour of the lips, contour of the nose, loops, arches, whorls and/or minutiae of a fingerprint, veins of a palm, and combinations thereof.

It is possible that the number of biometric characteristics, in particular of first and/or second biometric characteristics, is selected from the range from 50 to 200, preferably from 60 to 100, more preferably 65 to 70. It is even more preferable if the number 68 is selected for the number of biometric characteristics. In particular, all of the extracted first biometric characteristics are comprised by the first data set. In other words, in step b), a first data set is obtained which is based on all of the extracted first biometric characteristics.

It is thus possible to collect a number of biometric characteristics which allow adequately strong assignment to and thus identification of a person. An even higher number of biometric characteristics appears to be unnecessary, because accuracy increases only negligibly, but much larger data memories are required.

It is possible that the biometric characteristics, in particular the first biometric characteristics in the first data set or the second biometric characteristics in the third data set, are described and extracted as vectors and/or as coordinates in a coordinate system. It is furthermore also possible that the biometric characteristics, in particular the first and/or second biometric characteristics, are allocated to a type or a class, for example the basic pattern of a fingerprint. It is also possible that the biometric characteristics, in particular the first and/or second biometric characteristics, are described and extracted as binary data points, preferably of an iris scan. It is possible that the biometric characteristics, in particular the first and/or second biometric characteristics, are described and extracted as a combination of at least two of the aforementioned variants.

It is thus made possible for the position or form of the biometric characteristics, in particular of the first and/or second biometric characteristics, to be described in absolute terms and/or relative to other biometric characteristics and to one another.

It is possible that step b) for extracting the first biometric characteristics comprises at least the following sub-steps:
identifying and specifying a first region that is used for the extraction,
identifying the first biometric characteristics in the first region,
extracting the first biometric characteristics in the first region.

In particular, the first region is defined using the bounding rectangle method. Here, a rectangle is placed over the at least one biometric information item, for example a face. This is done such that preferably at least 90% of the first biometric characteristics are situated within the rectangle, wherein the rectangle preferably forms the smallest surrounding rectangle of the at least one biometric information item.

It is possible that the extraction of the first biometric characteristics in the first region is carried out by means of a method selected from the group consisting of holistic method, constrained local model method, regression-based method or combined method involving deep learning models and 3D shape models, preferably FacemarkLBF, FacemarkKazemi, FacemarkAAM, or combinations thereof. The extraction of the first biometric characteristics in the first region is preferably carried out by means of a combined method involving deep learning models and 3D shape models, preferably by means of FacemarkLBF.

In particular, a method is used which can identify and track at least one biometric information item and/or first biometric characteristic, for example on a real person, in a photograph, in a video and/or in a sequence of images. It is possible that the contours and/or centers of eyes, lips or nose are identified and/or tracked. It is also possible that loops, arches, whorls and/or minutiae of a fingerprint are identified and/or tracked. It is furthermore also possible that the veins in a palm are identified and/or tracked. Use is preferably made of a method that uses at least one neural network. Neural networks are preferably trained using large data sets relating to at least one biometric information item, preferably facial images in which, in particular, biometric characteristics have been manually marked. Said neural networks are preferably trained to identify patterns in data and to use said patterns to identify and track biometric characteristics. In particular, the method uses a cascaded regression model, wherein, in particular, the cascaded regression model comprises multiple layers of neural networks.

Holistic methods are to be understood to mean methods which explicitly model the appearance of the face as a whole and the global patterns of the face shape, for example the external face shape.

Constrained Local Model (CLM) methods are to be understood to mean methods which are based on the explicit local appearance of the face and explicit global patterns of the face shape.

Regression-based methods are to be understood to mean methods which use holistic or local appearance information items and which implicitly embed global face shape patterns for the joint identification of orientation points.

FacemarkLBF describes a model for identifying and tracking biometric information items, in particular facial recognition and face tracking. It is possible for FacemarkLBF to be trained to identify and track biometric information items of a face, a fingerprint, the palm veins, and/or an eye, preferably an iris and/or a retina. FacemarkLBF divides a biometric information item, for example a face, into sub-regions. It subsequently identifies and tracks features, in particular biometric characteristics, within said sub-regions. The FacemarkLBF model uses an algorithm which identifies and tracks these features, in particular biometric characteristics, in each sub-region of the biometric information item, for example face. A prediction is made as to where these features, in particular biometric characteristics, will be situated in the next image. An advantage of this is that the movements and changes in the biometric information item, for example in the face, can be tracked even if the biometric information item is in motion or the lighting is changing. The FacemarkLBF model uses a cascaded regression model.

The cascaded regression model is a machine learning method and comprises multiple layers of neural networks. Preferably, each neural network of a layer in the cascaded regression model is trained to identify and track particular features, in particular biometric characteristics, in a biometric information item, for example a face.

The output from a neural network of a first layer is preferably used as an input for a network of a second layer, which in turn identifies and tracks further features, in particular biometric characteristics. In this way, the tracking of biometric information items and/or characteristics becomes ever more precise and accurate.

Data sets comprising a large number of images are provided for training the cascaded regression model. The images comprise biometric information items and biometric characteristics. By means of the data sets, the cascaded regression model can be calibrated with regard to capturing the biometric characteristics displayed. By making a series of binary decisions, in particular by means of classifiers, the cascaded regression model learns how it can identify and track the biometric characteristics for which it is calibrated or to be calibrated. The cascaded regression model consists of a plurality of layers of classifiers that are applied sequentially in order to identify and/or track a particular feature or a particular property, in particular of a biometric characteristic. Each classifier of the cascaded regression model is a binary classifier. This means that the classifier either confirms or negates the presence of a particular feature or of a property, in particular of a biometric characteristic. In conjunction with the cascaded regression model, a plurality of layers of neural networks can be used to identify complex patterns in the input data and classify them into different categories. Each layer of the neural network can be regarded as a classifier which classifies a subset of the input data and forwards the output to the next layer in order to identify even more complex patterns. The cascading allows iterative processing of the data, enabling the model to achieve greater accuracy or performance.

The classifiers are applied in succession to an image, and only when a classifier delivers a positive result, in particular in the sense of identifying a characteristic, preferably at a particular position, is the next classifier applied to the image, in particular within the bounding rectangle.

Through the use of cascaded regression models, the advantage is achieved that complex features such as biometric characteristics, in particular first and/or second biometric characteristics, can be effectively and efficiently identified and tracked.

This is possible even if they appear at different angles or under different lighting conditions.

It is possible for a method to be used which can identify and track at least one biometric information item and/or at least one first biometric characteristic, wherein the method uses a convolutional neural network as a neural network.

A Convolutional Neural Network (CNN) is a neural network which is preferably used for processing images and/or other multi-dimensional data. It can be used for image recognition and image classification, identification of biometric information items, preferably facial recognition and/or speech recognition, and other applications or combinations thereof, in particular where it is necessary to process large volumes of complex data and data sets. A convolutional neural network preferably comprises at least two layers, wherein the at least two layers each perform different functions. The convolutional neural network preferably comprises at least one convolutional layer as a first layer and at least one pooling layer as a second layer. The layers are run through in succession proceeding from the first layer.

In the convolutional layer, a set of filters is convoluted onto the input image in order to generate one or more so-called feature maps. The one or more feature maps identify different features in an image, for example edges, textures and/or shapes.

The convolutional layer is followed in particular by a pooling layer, which reduces the size of the one or more feature maps and extracts the information items that are most relevant for further processing. The pooling layer may be configured in particular as a max pooling layer. The max pooling layer preferably extracts the maximum from each sub-region of the one or more feature maps.

The convolutional neural network may have further layers. The convolutional neural network preferably has one or more fully connected layers which follow the first and the second layer. The one or more fully connected layers combine features from the first and/or second layers and/or of preceding further fully connected layers, and each output a prediction. The prediction may for example include whether an input image represents a particular class of objects. The training of a convolutional neural network is carried out in the various layers through the optimization of weightings which best represent the features of the input image and deliver the highest accuracy in the classification of data.

The biometric characteristics, in particular the first and/or second biometric characteristics, may for example be identified and marked as points and/or coordinates in at least one biometric information item, for example a face. These biometric characteristics, in particular the first and/or second biometric characteristics, may be used to identify and track the at least one biometric information item irrespective of various states such as position and lighting. If the at least one biometric information item is a face, then this can be identified and tracked irrespective of different facial expressions, eye movements, viewing direction, facial hair, spectacles, head posture. It is possible for algorithms for identifying biometric characteristics, in particular the first and/or second biometric characteristics, to be used for the automatic identification of the most important points in an image and/or in a video.

In step c), the first data set, which is based on the extracted biometric characteristics, in particular the first biometric characteristics, is compressed. Step c) is preferably carried out after step b) and before step d).

In particular, at the start of step c), the first data set, which is based on the extracted first biometric characteristics, is preferably an array of 128 floating point numbers. Each floating point number preferably comprises 4 bytes. In other words, the first data set comprises a data volume of 128×4 bytes, that is to say 512 bytes.

Preferably, in step c), the data volume of each floating point number, preferably of the array of 128 floating point numbers, is reduced. In particular, the data volume of the first data set is reduced by a factor of 4. The data volume of each floating point number is compressed such that it preferably comprises 1 byte. In step c), a compressed first data set is obtained which preferably comprises 128×1 byte, that is to say 128 bytes.

It is possible for the quantization method to be used for the compression. In particular, each floating point number is reduced to a particular number of discrete values. The reduction of the floating point numbers is referred to in particular as rounding. The quantization preferably has the result that an integer is obtained for each floating point number. In particular, each floating point number is a 4-byte floating point number, and each integer is a 1-byte integer.

This offers the advantage that, as a result, the data volume of the first data set, and thus the data volume that must be comprised by the generated code, is reduced. This makes it possible for the method to be carried out on mobile devices or IoT devices which have limited resources such as memory and computing power. The reduction in size of the method parameters means that the demand for resources can be reduced, without this reduction having a significant adverse effect on the method, for example on the accuracy thereof.

In particular, embedding numbers are used for the reduction of the floating point numbers and for the compression, in step c), of the first data set. Through the use of embedding numbers, the floating point number can be scaled or normalized to a single byte. The embedding numbers are obtained in particular by means of a deep learning method. For the determination of the embedding numbers, LFW images may be used as training data or example data.

LFW images are a collection of facial images that have been collected as part of the “Labeled Faces in the Wild” (LFW) project. They serve as a benchmark test for facial recognition in order to test the performance of different algorithms for facial recognition. In particular, the LFW images consist of publicly available images and comprise a large number of people of different ethnicities, age groups and genders in different positions and with different expressions. The images are of varying quality, preferably resolution and lighting, and of different size. The LFW images have contributed to the development of new algorithms and technologies for facial recognition.

Embedding numbers for biometric characteristics, in particular for the first and/or second biometric characteristics, can be determined from image collections which are adapted to the specific biometric characteristics, in particular to the first and/or second biometric characteristics. This may for example be a collection of fingerprints or close-up images of eyes, in particular irises and/or retinas.

The embedding numbers represent typical, learned deviations in the training data. By means of these typical, learned deviations and the number of possible states in one byte, it is possible for 4-byte floating point numbers of the first biometric characteristics of the first data set or the second biometric characteristics of the third data set to be compressed into 1-byte integers of the compressed first or third data set respectively. Here, a byte preferably has 255 possible states. The training data are preferably selected in accordance with the particular application, in particular in accordance with the first biometric information item. In other words, for example, the training data comprise faces if the first data set and/or third data set comprises or is intended to comprise biometric characteristics of faces. Embedding numbers are therefore obtained in accordance with the particular application. The embedding width, in particular the embedding numbers, is/are preferably determined in accordance with the first data set and/or in accordance with the training data. The embedding width, in particular the embedding numbers, is/are determined such that, by means of the 4-byte floating point numbers of the first biometric characteristics of the first data set or of the second biometric characteristics of the third data set and the method according to the invention, 1-byte integers are obtained, in particular because the first and/or third data set relates directly and/or indirectly to the training data and/or the embedding width.

The compression advantageously acts on all biometric characteristics, in particular on the first and/or second biometric characteristics, such that the data remain internally consistent. Each 1-byte integer thus comprises the typical, learned deviation.

In order to map a floating point number onto the range of the embedding numbers, said floating point number is quantized. Quantizing is to be understood to mean the conversion into a discrete value within the range of the embedding numbers.

Step c) has in particular the following two sub-steps:
calculating the embedding width, in particular by means of embedding numbers,
quantizing a 4-byte floating point number of the first data set, in particular by means of the embedding width and the embedding numbers, to obtain a 1-byte integer.

The embedding width that is calculated in the first sub-step of step c) is in particular the difference between the highest and the lowest embedding number.

It is possible to calculate the embedding width using the following equation (1):

$$Embedding width = max ( Embedding numbers ) - min ( Embedding numbers ) \qquad ( 1 )$$

The second sub-step of step c), in which the 4-byte floating point number is quantized, in particular is mapped onto the range of the embedding numbers, can be described as follows:
subtracting the lowest embedding number from the 4-byte floating point number, wherein the result is divided by the embedding width, with a value in the 4-byte format within the embedding range being obtained,
dividing the previously obtained result by the 4-byte floating point number,
multiplying the previous result by the number of possible embedding values,
rounding the previous result to the next whole number, with a 1-byte integer being obtained.

In particular, the second sub-step of step b) may comprise the following equations (2) to (5):

$${x}_{1} = \frac{{x}_{0} - Min ( Embedding number )}{Embedding width} \qquad ( 2 )$$

$${x}_{2} = \frac{{x}_{1}}{{x}_{0}} \qquad ( 3 )$$

$${x}_{3} = {x}_{2} \cdot n \qquad ( 4 )$$

$${x}_{4} = Round ( {x}_{3} ) \qquad ( 5 )$$

Here, x₀ corresponds to the 4-byte floating point number, and x₄ corresponds to the 1-byte integer. x₁ to x₃ correspond to the intermediate results of the equations (2) to (4). The number of possible embedding values is abbreviated to n, where n preferably corresponds to 255.

In particular, the second sub-step of step c), that is to say the quantization of the 4-byte floating point number, may comprise one or more rounding steps between the calculation operations and/or the equations (1) to (5).

The use of the reduced, scaled integers advantageously does not result in a significant reduction in the accuracy of the identification of correspondence between two data sets based on biometric characteristics, in particular first and/or second biometric characteristics, for example for the purposes of document verification, in relation to the use of the original floating point numbers. The method according to the invention therefore exhibits high overall accuracy in relation to the use of an uncompressed data set, or leads to similar results during use. The term “overall accuracy” is preferably to be understood to mean the percentage of identical results from a system that uses a compressed data set in relation to a system that uses an uncompressed data set, for example in a process of verifying the code.

The overall accuracy of the method according to the invention is preferably at least 95%, more preferably at least 97.5%, even more preferably at least 98.9%, in particular in relation to a method involving an uncompressed first data set. The overall accuracy is expressed as a percentage and lies between 0% and 100%, where 100% indicates complete correspondence of the results from a system that uses a compressed data set in relation to a system that uses an uncompressed data set.

The positive accuracy is preferably at least 80%, more preferably at least 90%, even more preferably at least 98.2%. The negative accuracy is preferably at most 2%, more preferably at most 1%, even more preferably at most 0.5%.

The term “positive accuracy” describes the ability of a system to accurately identify and localize the actual correct position of the biometric characteristics, in particular of the first and/or second biometric characteristics, in the biometric information item, for example on the face. A system having high positive accuracy exhibits a greater likelihood that the biometric characteristics, in particular the first and/or second biometric characteristics, will be correctly/positively identified. A system having low positive accuracy exhibits a greater likelihood of incorrectly identifying or localizing the biometric characteristics, in particular the first and/or second biometric characteristics.

The term “negative accuracy” describes the error ratio or error rate in the identification and/or processing of biometric information items and/or biometric characteristics, in particular in facial recognition or face processing. It indicates the rate of incorrectly identified or incorrectly localized biometric characteristics, in particular first and/or second biometric characteristics. A high “negative accuracy” means that the system exhibits a high error ratio and has difficulty in accurately identifying and localizing biometric characteristics.

The positive accuracy and the negative accuracy are each expressed as a percentage, and each lie between 0% and 100%.

In step d), useful data are provided in at least one second data set. The second data set is added to the first data set. In particular, after the addition, the first data set comprises the at least one second data set. Step d) is preferably carried out after step c) and before step e).

The useful data may comprise or be data which specify the document in which the code is arranged and/or specify a person to which the document has been issued. Through the combination of biometric characteristics and document data and/or personal data, the authenticity and integrity of a document and the link to its owner are guaranteed.

It is possible that the useful data and/or the second data set contain document data selected from the group consisting of personal data, document type, issuing country, issuing authority, signer identifier, certification number, series number, check number, image data, document issue date, hand signature date, validity duration, machine-readable zone (MRZ), URL (Uniform Resource Locator), or combinations thereof.

It is possible that the useful data and/or the second data set contain one or more personal data selected from the group consisting of name, nationality, gender, eye color, height, hand signature, date of birth, place of birth or combinations thereof.

It is possible that the useful data and/or the second data set are provided as a data type which is selected from the group consisting of alphanum, string, multistring, date, float, integer, binary or combinations thereof.

In step e), a first hash value of the compressed first data set or of the compressed first data set and the second data set is generated. Step e) is preferably carried out after step d) and before step f).

A hash value, in particular the first and/or the second hash value, is obtained by means of a hash function. One or more data sets are entered as an input into the hash function. As an output, a unique cryptographic hash value, in particular first and/or second hash value, is generated. In particular, the hash function is irreversible. In other words, it is in particular not possible for the one or more data sets that were provided and input for the calculation of the hash value, in particular the first and/or second hash value, to be reconstructed and obtained from the hash value. Hash values offer the advantage that they ensure the integrity of data sets, in particular by ensuring that the data sets have not been tampered with and/or cannot be tampered with, and/or that no data sets containing errors are present. In particular, a signature is created by means of the first hash value and a signature algorithm, in particular in step f).

The one or more data sets for the input may preferably be based on biometric characteristics, in particular on first and/or second biometric characteristics, and/or on useful data, and may more preferably comprise at least the compressed first data set or additionally also the second data set.

Step e) preferably comprises the following sub-steps, more preferably in the stated sequence:
e1) providing at least the compressed first data set or the compressed first data set and the second data set, and providing a hash function,
e2) inputting at least the compressed first data set or the compressed first data set and the second data set into the hash function,
e3) calculating the first hash value from at least the compressed first data set or from the compressed first data set and the second data set,
e4) outputting the first hash value.

The hash value, in particular the first hash value and/or the second hash value, preferably has a unique and/or fixed length of a character string of hexadecimal numbers. An SHA-1 function or an SHA-2 function, preferably an SHA-256 function, or an SHA-3 function is preferably provided as a hash function. In particular, an SHA-256 function is provided. A 256-bit hash value is preferably obtained as a hash value, in particular the first hash value and/or the second hash value. The hash value, in particular the first hash value and/or the second hash value, is preferably a hexadecimal number with 64 digits.

In step f), a signature is generated for the first hash value that was obtained in step e). Step f) is preferably carried out after step e) and before step g).

It is possible that the first hash value is asymmetrically encrypted, in particular in step f). A signature is preferably generated by means of a signature algorithm, in particular by using a Digital Signature Algorithm (DSA). It is possible that the signature algorithm uses elliptic curve cryptography. An Elliptic Curve Digital Signature Algorithm (ECDSA) is particularly preferably used as a signature algorithm to generate the signature.

The elliptic curve digital signature algorithm is a cryptographic method for signing data, which is based on elliptic curves and generates a signature comprising two signature parameters.

The elliptic curve with the designation “brainpool256r1” is preferably used for calculating the signature. In particular, the signature comprises a first signature parameter r and a second signature parameter s. The first signature parameter r and the second signature parameter s are preferably each 256 bits in length. The data volume for the first and the second signature parameter is preferably 512 bits or 64 bytes.

Step f) preferably comprises the following sub-steps, which are preferably carried out in the stated sequence:
selecting an elliptic curve and a base point on the elliptic curve, wherein, in particular, the curve and the base point are publicly known,
selecting a random secret integer referred to as a private key, wherein the private key is used to calculate a public key, wherein the public key lies on the selected elliptic curve,
providing the first hash value generated in step e),
selecting a random number as a signature key,
calculating the first signature parameter r, wherein the first signature parameter r corresponds to the x coordinate value of the point obtained by multiplying the base point by the signature key,
calculating the second signature parameter s, wherein the second signature parameter s is obtained by virtue of the result of a multiplication of the inverse of the signature key by the first hash value, and subsequent addition of the private key, being modulated by the order of the elliptic curve.

The validity of the signature is preferably checked in particular in a step of the method for verification purposes. A valid signature serves in particular as evidence of the integrity of the data. The data have then not been tampered with.

To check the validity of the signature, it is preferably the case that at least the following sub-steps are carried out, preferably in the stated sequence:
calculating a second hash value from the compressed first data set or from the compressed first data set and the second data set,
decrypting the signature using the public key of the sender, with the first hash value being obtained,
comparing the newly calculated second hash value and the first hash value.

The “sender” is to be understood to mean the original creator of the code and the signature, that is to say the party that has carried out the method, in particular step f) or the sub-steps of step f), in order to generate the code. The public key is provided, preferably in an item of verification software or on a server.

In particular if the original hash value, in particular the first hash value, corresponds to the newly calculated hash value, in particular the second hash value, then the data sets have not been tampered with (integrity). If the signature cannot or has not been able to be successfully verified using the public key of the sender, then the signature is invalid, or the incorrect public key has been used.

The hash value for checking the validity of the signature, in particular the second hash value, is preferably calculated using a hash function. In particular, the same hash function as described in step e) is used. The hash function is preferably an SHA-256 function. In particular, the calculation of the second hash value comprises the sub-steps of step e), wherein the second hash value is obtained instead of the first hash value.

A signature, preferably an ECDSA 256-bit signature, more preferably when using the SHA-256 function, in particular using the brainpool256r1 curve, preferably has a size of 64 bytes.

In step g), a code is obtained which is based on the compressed first data set. The code therefore makes it possible for the biometric data extracted in step b) to be retrieved, evaluated and verified. Step g) is preferably carried out after step f). It is possible to generate the code by means of an algorithm known from the prior art.

The code is preferably in the form of a geometrical and graphical pattern. It is possible for the code to be generated as a machine-readable 2D code, preferably a matrix code, QR code, Micro QR code, DataMatrix code, MaxiCode, Aztec code, JAB code, Han Xin code, a DotCode, a stacked code, preferably Codablock, Code 49, PDF417, or a combination thereof. The 2D code may preferably be combined with a 1D code. The code is in particular not a 1D code and/or not human-readable.

The code preferably has a dimension of 20 mm×20 mm. The code preferably has 80 modules×80 modules.

A module is to be understood to mean the smallest binary graphical unit of which a code can be composed. For example, in a QR code, one module is one white or one black pixel and/or one point.

It is possible that the code exhibits error correction.

Error correction is preferably to be understood to mean that it is possible for errors in the transmission and/or reading of data sets from a code to be identified and corrected. This is achieved by virtue of redundant data information items being added to the first data set or to the compressed first data set. A data set and/or code may thus comprise up to a defined percentage of redundant data. In other words, some information items or data elements of the first compressed data set and/or of a header and/or of the first hash value and/or of the signature are at least duplicated. The redundant data information items may be used by a reading device to identify errors and/or to correct these during the reading-out process.

The error correction preferably comprises a Reed-Solomon code, whereby it is possible to carry out a Reed-Solomon error correction method. A Reed-Solomon error correction method makes it possible to identify erroneous and/or absent data elements, and/or to correct these during the reading-out process.

The advantage is thus achieved that the data sets obtained from the code can be read out even in the presence of errors in up to 7%, 15%, 25% or 30% of the data elements of the data set, depending on the error correction level.

There are different error correction levels which differ in terms of the percentage of redundant data. The code preferably exhibits error correction on the levels L, M, Q, or H, preferably the levels L, M or Q. In particular, the code exhibits error correction on the level L.

The error correction on the level L can correct up to 7% of data elements. In other words, up to 7% of the data elements may be absent and/or incorrectly read, wherein it is nevertheless possible for the code, in particular 100% of the code, to be read out.

The error correction M can correct up to 15% of the data elements. This means that up to 15% of the data elements may be absent and/or incorrectly read, wherein it is nevertheless possible for the code, in particular 100% of the code, to be read.

The error correction on the level Q can correct up to 25% of data elements, and the error correction on the level H can correct up to 30% of data elements. In other words, up to 25% or 30% of the data elements may be absent and/or incorrectly read, wherein it is nevertheless possible for the code, in particular 100% of the code, to be read.

The code comprises at least the compressed first data set or additionally the second data set with the useful data, comprises the first hash value of the compressed first data set or additionally also of the second data set with the useful data, comprises a signature, preferably comprises a header, and preferably comprises error correction. It is possible that the header is part of the useful data. It is thus possible that the header is comprised by the hash value, in particular by the first and/or second hash value. It is possible that the error correction is not comprised by the hash value, in particular by the first and/or second hash value.

A header comprises standard information items required for a code. These standard information items preferably comprise information items relating to the document on which the code is arranged, more preferably type, version and issuing country of the document.

The code may preferably comprise a data volume selected from the range from 1 byte to 520 bytes, preferably from 32 bytes to 412 bytes. In particular, the data volume comprises at least the compressed first data set, the first hash value, the signature and optionally the header.

It is possible that the code, in particular before it is arranged on a document, is embedded into a two-dimensional discrete complex function G(fx, fy) having an fx frequency coordinate and an fy frequency coordinate, and the two-dimensional discrete complex function G(fx, fy) is Fourier-transformed and is binarized to form a two-dimensional image. The two-dimensional image obtained is arranged on the document. A method for verifying such a code has a further step for retransformation, which is carried out before the compressed first data set is read out from the code.

This offers the advantage that the protection against forgery of the code is further enhanced, because, to decrypt the code, the further step of retransformation is required before the code can be verified.

It is possible that the code is arranged on or in a document. The code is preferably configured such that it can be arranged and/or used in a document.

It is possible that the code exists, is provided and/or is used in digital form, for example as a PDF or as an image file. The code may exist and/or be used in digital form on a device of an end user, preferably smartphone and/or tablet and/or computer. It is alternatively possible that the code exists or is used as embossment and/or as a printed layer.

It is possible that the document is, or is provided as, a certificate, deed, ticket, preferably flight ticket, rail ticket, event ticket, concert ticket, conference ticket, entry ticket, an access control document, or an official document, preferably visa, residence permit, proof of arrival, temporary identity document, residence title.

In particular, the document comprises one or more personal data selected from the group consisting of name, nationality, gender, photograph, hand signature, date of birth or combinations thereof. The personal information items are in particular human-readable and/or machine-readable.

It is possible that the document comprises the useful data, which are comprised by the code, in human-readable and/or machine-readable form.

It is possible that the document is provided and/or exists in digital form, preferably as a PDF or as an image file, or in physical form.

If the document exists in physical form, it is possible that the document has one or more security elements selected from the group consisting of security print, metal layer, RFID chip, optically variable security element, machine-readable element or combinations thereof.

The optically variable security element preferably has an optically active relief structure selected from the group consisting of diffraction grating, hologram, zeroth-order diffraction structure, blaze grating, macrostructure, in particular lens structure or microprism structure, mirror surface, matte structure, in particular anisotropic or isotropic matte structure. It is possible that the optically variable security element has elements selected individually or in combination from the group consisting of metallic reflection layer, high-refractive-index (HRI) reflection layer, volume hologram, thin-film structure with color change effect, in particular Fabry-Pérot three-layer thin-film structure, liquid crystal material, preferably nematic or cholesteric liquid crystal material, dyes and/or pigments, preferably phosphorescent pigments, luminescent pigments, thermochromic pigments and/or optically variable pigments.

Alternatively, the document, in particular if it exists in digital form, may have at least one or more security elements selected from the group consisting of digital watermark, electronic and/or digital signatures, asymmetric and/or symmetric encryptions, digital hand signatures, password protection or combinations thereof.

The code may partially or fully overlap, or be partially or fully overlapped by, a security element, in particular in a view directed perpendicularly onto the plane spanned by the document. It is possible that the code is partially or fully comprised by a decorative element of the document. The code may partially or fully overlap, or be partially or fully overlapped by, the decorative element.

The method, in particular one, two or more steps of the method, for verifying the code may be carried out on an external server and/or carried out locally on a device. It is possible that the device has no network connection. In particular, the method is configured for verifying the code according to the invention.

It is preferably possible for one, two or more steps of the method for verifying the code to be executed on a device which is selected from the group consisting of smartphone, camera, tablet, PC, terminal, IoT devices or combinations thereof. The device has at least one apparatus for capturing images, and has a processor for carrying out at least one further step of the method.

In step A), a compressed third data set is created, wherein the compressed third data set is based on second biometric characteristics. The biometric characteristics captured and extracted in step A) are referred to as second biometric characteristics. Preferably, in step A), data, for example a photograph or a video, are transmitted to or created by a server, a client device or a device.

The transmitted or created data are optionally checked in step A). In particular, the image quality, the orientation, the detail and/or the presence of adequate lighting may be checked.

In particular, it is possible that, in step A), at least the following points are checked on the server, on the client device or on the device:
checking whether at least one biometric information item is present,
checking whether a single biometric information item or two or more biometric information items is or are present,
checking whether the at least one biometric information item is present with dimensions selected from the range of at least 100×100 pixels, preferably at least 80×80 pixels.

It is possible that the orientation of the biometric information item is optionally checked on the server, on the client device or on the device. Here, the orientation is checked in respect of at least an x direction, a y direction and a z direction, wherein, in particular, the roll-pitch-yaw angles are used. Roll is to be understood to mean the rotation in the longitudinal direction of the x axis or longitudinal axis of the at least one biometric information item. Pitch is to be understood to mean the rotation about the y axis or transverse axis of the at least one biometric information item. Yaw is to be understood to mean the rotation about the z axis of the reference system, or vertical axis.

If a face is taken as a biometric information item, for example, then a longitudinal axis can be understood as an imaginary axis which enters the front of the head and exits the rear of the head. Here, the y axis corresponds to an imaginary axis which extends from one ear to the ear situated on the opposite side of the head. The z axis is perpendicular to the x axis and to the y axis and extends from the top of the head in the direction of the larynx. The roll-pitch-yaw angles can assume values between 0° and 360°. The x, y and z axes are each perpendicular to one another.

The yaw angle is preferably selected from the range from 324° to 36°, more preferably from 336° to 24°, even more preferably from 348° to 12°. In other words, the deviation from 0° is preferably up to 36°, more preferably up to 24°, even more preferably up to 12°.

The roll angle is preferably selected from the range from 221° to 299°, preferably from 234° to 286°, more preferably from 247° to 273°. In other words, the deviation from 260° is preferably up to 39°, more preferably up to 26°, even more preferably up to 13°.

It is possible not to evaluate the pitch angle, or to evaluate only the yaw angle and the roll angle.

The check of the image quality is evaluated as being successful if at least one biometric information item is identified and this is present with the above-described minimum number of pixels, and the orientation of the biometric information item lies within the above-described angles, in particular yaw angle and roll angle.

If the check is assessed as being unsuccessful, that is to say the image quality is not, as described above, assessed as being adequate for successfully carrying out the further method steps, then a signal is generated and, preferably, a renewed input of biometric information items is requested and/or the check is repeated. The signal may be a visual or acoustic signal and/or displayed text. If the check is assessed as being successful, then the next step or sub-step is carried out.

Preferably, in step A), the second biometric characteristics are extracted in particular by means of a neural network, wherein, in particular, the neural network is preferably a convolutional neural network. It is possible that the sub-step for extracting the second biometric characteristics in step A) is carried out as described above with regard to step b).

For example, DeepFace or FaceNet may be used for extracting the biometric data, in particular in step A), wherein these comprise convolutional neural networks.

The biometric information items and/or biometric second characteristics may be compressed as already described above, in particular analogously to step c). The third data set is preferably quantized. A compressed third data set is preferably obtained, which has 1-byte integers in which the second biometric characteristics are stored. The third compressed data set is based on the second biometric characteristics extracted, in step A), from at least one biometric information item.

Alternatively to step A), it is possible in step B) for the third compressed data set to be provided by a database, wherein the database comprises at least one third data set. The third data set is preferably based on second biometric characteristics. The third compressed data set preferably has 1-byte integers. The third data set is preferably encoded in Base64. The database is preferably provided by accessing an external server, or is present locally on the device. Preferably, no signature and/or no hash value is present for the compressed third data set.

In step h), a code is preferably provided which is based on first biometric characteristics. Preferably, the code has been generated in accordance with the method according to the invention for generating a code. In particular, the first biometric characteristics correspond to the biometric characteristics that were captured and extracted in steps a) and b). In step h), the compressed first data set is firstly read out of the code. Subsequently, the compressed first data set based on the first biometric characteristics is compared with the compressed third data set based on the second biometric characteristics.

Subsequently, in step i), an evaluation parameter for the difference between the compressed first data set and the compressed third data set is selected and calculated. The evaluation parameter makes it possible to evaluate whether the compressed first data set and the compressed second data set are based on the biometric characteristics of the same person.

The evaluation parameter may for example be a distance, preferably in a 2D image space, between the compressed first data set and the compressed third data set.

A triplet loss algorithm is preferably used to determine the evaluation parameter.

The triplet loss algorithm is a machine learning method in which embeddings are preferably generated using a specific type of loss function in conjunction with neural networks. Embeddings are preferably generated which reflect a semantic similarity between different input examples. The triplet loss algorithm allows a distinction to be made between similar objects which are assigned to different so-called classes. The triplet loss algorithm has the aim of maximizing the distance between positive and negative examples in an embedding space, whilst the triplet loss algorithm simultaneously minimizes the distances between the examples within the same class.

It is substantially the case that three images are entered as inputs into the algorithm: an “anchor” (A), a “positive example” (P) and a “negative example” (N). The algorithm firstly learns to minimize the distance between the anchor and the positive example, because these belong to the same class. Secondly, the distance between the anchor and the negative example is maximized, because these belong to different classes. The loss in the triplet loss algorithm refers to the distance between the anchor and the positive example minus the distance between the anchor and the negative example, plus a margin. The margin is a constant.

In particular, the loss in the triplet loss algorithm can be determined using the following equation (6):

$$Loss = Distance ( A and P ) - Distance ( A and N ) + Margin \qquad ( 6 )$$

The anchor (A) and the positive example (P) are preferably both images of the same person, and an image of another person is provided as a negative example (N). A trained neural network with the triplet loss algorithm causes the neural network to display faces in a particular manner in a 2D image space (“embedding space”). In this 2D image space, faces belonging to the same person are positioned close together, that is to say with a small distance. Faces of different people are displayed further apart from one another, that is to say with a greater distance.

Thus, during the training of the neural network, the triplet loss algorithm is used to optimize the embeddings such that they are useful for facial recognition. What is used for the extraction of the embeddings is then the trained neural network. The embeddings may then be compared with a Euclidean distance. If the measured distance between the two embeddings is small, this indicates that they relate to the same person. Accordingly, if the distance is large, then they likely relate to different people.

An embedding is to be understood to mean a compact representation of data, preferably a unique representation of biometric characteristics, in particular first and/or second biometric characteristics.

In step j), it is evaluated whether the evaluation parameters obtained lie within a specified order of magnitude or value range or do not exceed a specified threshold value. If the evaluation parameter lies within the specified order of magnitude or value range or below the threshold value, a positive evaluation is output. If the evaluation parameter lies outside the specified order of magnitude or the value range or above the threshold value, a negative evaluation is output.

A positive evaluation is to be understood to mean that the first and second biometric characteristics on which the compressed first and the compressed third data set are based correspond, wherein it has been verified that these originate from the same person.

The evaluation is preferably output as a visual or acoustic signal and/or displayed text, wherein the output distinguishes between positive and negative evaluation.

The method for verifying a code preferably comprises the further step:
checking the validity of the signature.

This step is preferably carried out during or after step A) or B) and before step h). The check is carried out as stated above, and may comprise the sub-steps provided there.

In particular, if the check yields that the signature is invalid, that is to say that the data have been tampered with, a signal is output, and the method is preferably ended. The signal may for example be a visual or acoustic signal and/or displayed text.

A preferred method for generating a code has at least the following steps a), b), c), d), e), f) and g), preferably in the stated sequence. A preferred method for verifying a code has at least the following steps A), h), i) and j) or B), h), i) and j), preferably in the stated sequence. It is also possible that, in the method, the method steps are carried out once or several times. In particular, method steps in the method may be repeated, and/or the method steps of the method may comprise sub-steps.

Product features mentioned above may self-evidently be used equivalently in a method, or method features that have been mentioned may be used in the product.

The invention will be discussed by way of example below on the basis of a plurality of exemplary embodiments and with reference to the appended drawings. The exemplary embodiments shown are therefore not to be understood as limiting.

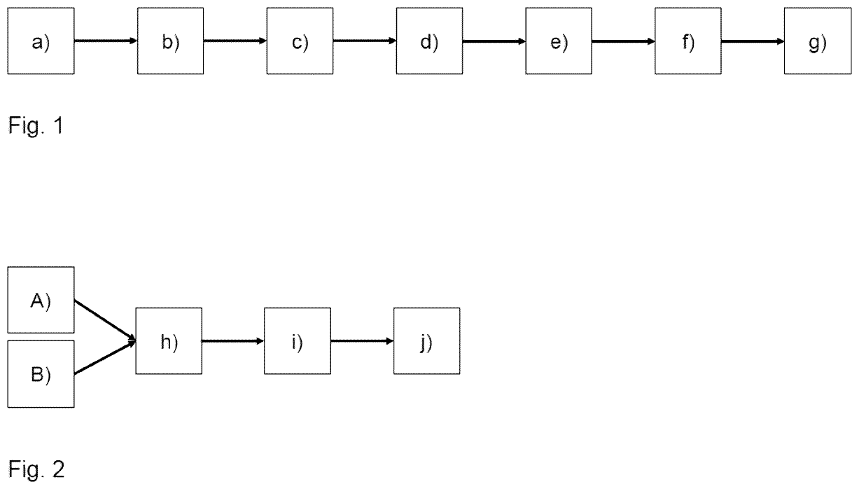

FIG. 1 is a schematic illustration of a sequence of the method for generating a code which has a compressed first data set based on first biometric characteristics.

FIG. 2 is a further schematic illustration of a sequence of a method for verifying a code which has a compressed first data set based on first biometric characteristics.

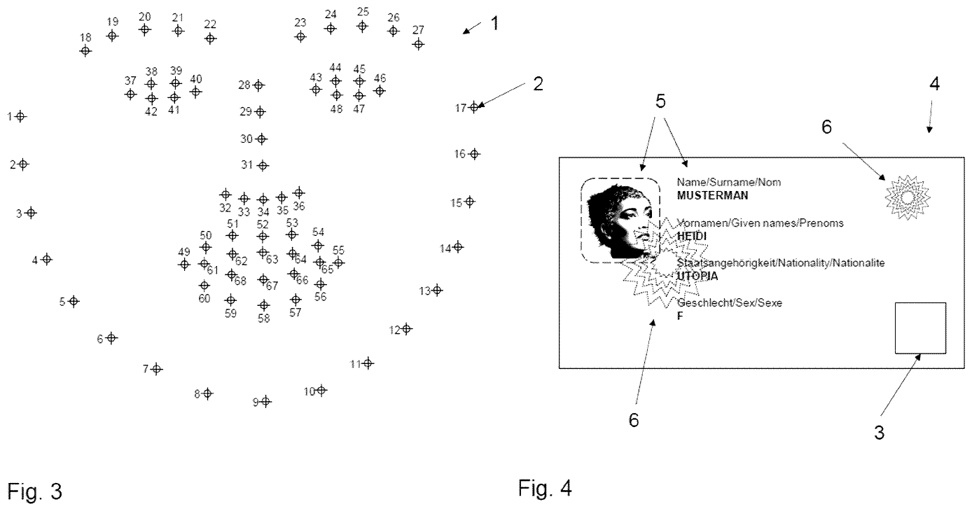

FIG. 3 is a schematic illustration of first and/or second biometric characteristics.

FIG. 4 is a schematic illustration of a document.

FIG. 1 shows a schematic sequence of the method for generating a code 3 which has a compressed first data set based on first biometric characteristics 2′. The code 3 generated in the method according to FIG. 1 can be verified by means of the method schematically described in FIG. 2, in which second biometric characteristics 2″ are extracted and a compressed third data set based on the second biometric characteristics 2″ is created. For verification, the compressed first and third data sets are compared with one another.

The method for generating the code 3 has at least the following steps, which are carried out in particular in the sequence indicated in FIG. 1:
a) capturing at least one biometric information item 1 from a real person, a photograph and/or a video,
b) extracting first biometric characteristics 2′ from the at least one biometric information item 1, in particular by means of a neural network, in the form of a first data set,
c) compressing the first data set to obtain a compressed first data set,
d) adding a second data set comprising useful data to the compressed first data set,
e) generating a first hash value of the compressed first data set or of the compressed first data set and the second data set,
f) generating a signature for the first hash value,
g) generating the code 3 in the form of a geometrical pattern comprising the first compressed data set, which is based on the first biometric characteristics 2′, and comprising the first hash value and the signature.

Step a) is preferably the first step of the method, and is carried out before step b).

FIG. 3 is a schematic illustration of a face, the biometric information item 1 of which is captured. It is also possible that the biometric information item 1 of a fingerprint, palm veins, and/or an eye, preferably an iris and/or a retina, is captured. It is possible that the at least one biometric information item 1 exists and/or is captured in two-dimensional and/or three-dimensional form.

It is possible that the at least one biometric information item 1 is captured by means of a device selected from the group: smartphone, camera, tablet, PC, terminal, IoT devices or combinations thereof. The device has at least one apparatus for capturing images, and has a processor for carrying out at least one further step of the method.

It is possible that the device is a client device, and the at least one biometric information item 1 is transmitted via a network to an external server, on which one or more or all of the subsequent steps are carried out. It is alternatively possible that all of the steps of the method are carried out locally on the device, preferably without a network connection to an external server.

In step b), biometric characteristics 2′ are extracted, in particular identified and extracted, from at least one biometric information item 1. Step b) is preferably carried out after step a) and before step c).

It is possible that, as schematically shown in FIG. 3, one or more of the biometric characteristics 2, in particular the first and/or second biometric characteristics 2′, 2″, are selected from the group consisting of tip of the nose, corner of the eye, eyebrow and tip of the chin, contour of the eyes, contour of the lips, contour of the nose, loops, arches, whorls and/or minutiae of a fingerprint, veins of a palm, and combinations thereof.

It is possible that the number of biometric characteristics 2, in particular of first and/or second biometric characteristics 2′, 2″, is selected from the range from 50 to 200, preferably from 60 to 100, more preferably from 65 to 70. It is even more preferable if, as shown in FIG. 3, the number 68 is selected for the number of biometric characteristics 2, in particular first and/or second biometric characteristics 2′, 2″. In particular, in step b), a first data set is obtained which is based on all of the extracted first biometric characteristics 2′.

It is possible that the biometric characteristics 2, in particular the first biometric characteristics 2′ in the first data set or the second biometric characteristics 2″ in the third data set, are described and extracted as vectors and/or as coordinates in a coordinate system. It is furthermore also possible that the biometric characteristics, in particular the first and/or second biometric characteristics 2′, 2″, are allocated to a type or a class, for example the basic pattern of a fingerprint. It is also possible that the biometric characteristics 2, in particular the first and/or second biometric characteristics 2′, 2″, are described and extracted as binary data points, preferably of an iris scan. It is possible that the biometric characteristics 2, in particular the first and/or second biometric characteristics 2′, 2″, are described and extracted as a combination of at least two of the aforementioned variants.

It is possible that step b) for extracting the first biometric characteristics 2′ comprises at least the following sub-steps:
identifying and specifying a first region that is used for the extraction,
identifying the first biometric characteristics 2′ in the first region,
extracting the first biometric characteristics 2′ in the first region.

In particular, the first region is defined using the bounding rectangle method. Here, a rectangle is placed over the at least one biometric information item 1, for example a face, wherein, in particular, preferably at least 90% of the first biometric characteristics 2′ are situated within the rectangle. The rectangle is preferably the smallest surrounding rectangle of the at least one biometric information item 1.

It is possible that the extraction of the first characteristics 2′ in the first region is carried out by means of a method selected from the group consisting of holistic method, constrained local model method, regression-based method or combined method involving deep learning models and 3D shape models, preferably FacemarkLBF, FacemarkKazemi, FacemarkAAM, or combinations thereof. The extraction of the first biometric characteristics 2′ in the first region is preferably carried out by means of a combined method involving deep learning models and 3D shape models, preferably by means of FacemarkLBF.

In particular, a method is used which can identify and track at least one biometric information item 1 and/or one first biometric characteristic 2′, for example on a real person, in a photograph, in a video and/or in a sequence of images. It is possible that the contours and/or centers of eyes, lips or nose are identified and/or tracked. It is also possible that loops, arches, whorls and/or minutiae of a fingerprint are identified and/or tracked. It is furthermore also possible that the veins in a palm are identified and/or tracked. Use is preferably made of a method that uses at least one neural network.

The biometric characteristics 2, in particular the first and/or second biometric characteristics 2′, 2″, may for example be identified and marked as points and/or coordinates in a biometric information item 1, for example a face. In step c), the first data set, which is based on the extracted biometric characteristics 2, in particular the first biometric characteristics 2, 2″, is compressed. Step c) is preferably carried out after step b) and before step d).

In particular, at the start of step c), the first data set, which is based on the extracted first biometric characteristics 2′, is preferably an array of 128 floating point numbers.

Each floating point number preferably comprises 4 bytes. In other words, the first data set comprises a data volume of 128×4 bytes, that is to say 512 bytes.

Preferably, in step c), the data volume of each floating point number, preferably of the array of 128 floating point numbers, is reduced. In particular, the data volume of the first data set is reduced by a factor of 4. The data volume of each floating point number is compressed such that it preferably comprises 1 byte. A compressed first data set is obtained which preferably comprises 128×1 byte, that is to say 128 bytes.

It is possible for the quantization method to be used for the compression. In particular, each floating point number is reduced to a particular number of discrete values. The quantization preferably has the result that an integer is obtained for each floating point number.

In particular, embedding numbers are used for the reduction of the floating point numbers and for the compression, in step c), of the first data set. The embedding numbers are obtained in particular by means of a deep learning method. For the determination of the embedding numbers, LFW images may be used as training data or example data.

Embedding numbers for biometric characteristics 2, in particular for the first and/or second biometric characteristics 2′, 2″, can be determined from image collections which are adapted to the specific biometric characteristics 2, in particular to the first and/or second biometric characteristics 2′, 2″. This may for example be a collection of fingerprints or close-up images of eyes, in particular irises and/or retinas.

By means of the embedding numbers, it is possible for 4-byte floating point numbers of the first biometric characteristics 2′ of the first data set or the second biometric characteristics 2″ of the third data set to be compressed into 1-byte integers of the compressed first or third data set respectively. Here, a byte preferably has 255 possible states.

The compression advantageously acts on all biometric characteristics 2, in particular on the first and/or second biometric characteristics 2′, 2″, such that the data remain internally consistent.

Step c) has in particular the following two sub-steps:
calculating the embedding width, in particular by means of embedding numbers,
quantizing a 4-byte floating point number of the first data set, in particular by means of the embedding width and the embedding numbers, to obtain a 1-byte integer.

From 1000 LFW images, it would for example be possible, for the quantization from 4 bytes to 1 byte, to determine embedding numbers from −0.52077 to 0.58290. If other LFW images or a different number of LFW images are used, other embedding numbers may be obtained. For the following example, it can for example be assumed that a first data set is provided which, in particular, comprises 4-byte floating point numbers from a range from 10.000 to 511.000.

The embedding width can be calculated by means of the above-described equation (1), as follows:

$$Embedding width = 0.5829 - ( - 0.52077 ) = 1.10367 \qquad ( 7 )$$

The second sub-step of step c), in which the 4-byte floating point number is quantized, in particular is mapped onto the range of the embedding numbers, can be described as follows:
subtracting the lowest embedding number from the 4-byte floating point number, wherein the result is divided by the embedding width, with a value in the 4-byte format within the embedding range being obtained,
dividing the previously obtained result by the 4-byte floating point number,
multiplying the previous result by the number of possible embedding values,
rounding the previous result to the next whole number, with a 1-byte integer being obtained.

In particular, the second sub-step of step b) may be carried out by means of the equations (2) to (5) described further above. In particular, the second sub-step of step c), that is to say the quantization of the 4-byte floating point number, may comprise one or more rounding steps between the calculation operations and/or the equations (1) to (5).

For example, if it is sought to convert the floating point number 10.000 into an integer using the exemplary embedding numbers and the determined embedding width, then the calculation operation based on the equations (2) to (5) described further above would be as follows:

$${x}_{1} = \frac{10. - ( - 0.52077 )}{1.10367} = 9.532532369277048$$

$${x}_{2} = \frac{9.532532369277048}{10.} = 0.9532532369277048$$

$${x}_{3} = 0.9532532369277048 \cdot 255 = 243.0795754165647$$

$${x}_{4} = Round ( 243.0795754165647 ) = 243$$

The value quantized from the 4-byte floating point number 10.000 is therefore the 1-byte integer 243.

For example, if it is sought to convert the 4-byte floating point number 511.000 into the format of a 1-byte integer, then the result, according to equations (2) to (5), is as follows:

$${x}_{1} = \frac{511. - ( - 0.52077 )}{1.10367} = 463.4725687932081$$

$${x}_{2} = \frac{463.4725687932081}{511.} = 0.9069913283624425$$

$${x}_{3} = 0.9069913283624425 \cdot 255 = 231.2827887324228$$

$${x}_{4} = Round ( 231.2827887324228 ) = 231$$

The 231 thus corresponds to the 511.000, but in the form of a 1-byte integer rather than a 4-byte floating point number.

An exemplary first data set such as may be present in particular before step c) is shown below. It comprises 128 floating point numbers as float, which each comprise 4 bytes. This first data set therefore comprises 512 bytes.

[
−0.05925874 −0.01128396 0.09105307 −0.03127807 −0.06801271 0.00182864
0.02190954 −0.03301878 0.1174328 −0.12124632 0.2046176 −0.03022786
−0.1650396 −0.03561758 0.02826818 0.04809535 −0.08440463 −0.13857858
−0.04214942 −0.12700349 0.0040139 0.0755067 −0.04215983 0.02811784
−0.18864852 −0.32442543 −0.10503909 −0.12915151 0.04021796 −0.09991094
−0.02277122 0.12424234 −0.07866608 −0.02084278 0.04711079 0.13625742
−0.084192 −0.06349151 0.16590628 0.0514999 −0.1250737 0.05737659
−0.02666266 0.39832145 0.19206464 0.02395936 0.0366288 0.01073211
0.14245601 −0.28562331 0.14108598 0.12950768 0.1153863 0.03340553
0.13990811 −0.05962767 −0.05303854 0.09821685 −0.12946202 0.14813364
0.073308 −0.10102654 0.00718761 −0.13756338 0.13108446 0.04731053
−0.1450232 −0.03344052 0.10073769 −0.18781862 −0.09244437 0.04796299
−0.14790541 −0.18098995 −0.24642134 0.1148652 0.37924495 0.20492479
−0.14766243 0.01187875 0.01043329 0.02256429 0.12094933 0.12964407
−0.01805194 −0.02777201 −0.0671116 0.06098519 0.20639569 −0.02059942
−0.08582722 0.20526092 −0.05562493 0.03028861 0.0125723 0.00467008
−0.06393289 −0.0395912 −0.09014382 0.01064388 0.04050598 −0.07019708
−0.02232645 0.11580256 −0.15094413 0.19078945 −0.05291561 0.02259036
0.02638829 −0.0248037 −0.12892082 0.01049134 0.16260809 −0.25910816
0.07229158 0.18393528 0.03622625 0.13120936 0.06309938 −0.02336612
0.02109955 −0.04417466 −0.20827481 −0.07516982 0.03874544 0.03451699
0.00411214 0.01026958
]

The above first data set is compressed as described in step c), and the floating point numbers are converted into integers, wherein, in particular, a specific embedding width has been determined for the exemplary first data set. Below, it is shown how the above first data set could be present, after step c), as a compressed first data set, now comprising 128 integers of 1 byte each. This compressed data set therefore comprises 128 bytes.

[
103 114 139 109 101 117 122 109 145 88 166 110 77 108 124 128
97 84
107 86 118 135 107 124 72 39 92 86 127 93 111 147 98 112
128 150
97 102 157 129 87 131 111 212 163 123 126 120 151 48 151 148
145 125
150 103 104 140 86 152 135 93 119 84 148 128 82 109 141 72
95 128
81 74 58 144 208 166 82 120 119 122 146 148 113 110 101 132
166 112
96 166 104 124 120 118 102 107 95 119 127 100 112 145 81 163
104 122
123 111 86 119 156 55 134 161 126 148 132 111 122 106 67 99
126 125
118 119
]

The first data set or the compressed first data set is presented below in Base64 encoding, with the two data sets as float. It hereby sought to further illustrate the difference achieved by a compression. A Base64-encoded data set of an array of 128 4-byte floating point numbers appears for example as follows:

S7lyvVzgOLwIero9bx0AvT9Ki736ru86o3uzPLM+B72cgPA9/k/4vUeHUT5roP
e8JAApvr3jEb2skuc8of9EPVbcrL2L5w2+36QsvTQNAr4Jh4M7QqOaPcmvLL1i
V+Y8FC1Bvhcbpr68Hte9S0AEvpa7JD0bnsy9toq6vMVy/j2vG6G9er6qvD73QD
0Rhws+22ysvdYHgr1W4yk+j/FSPVITAL63A2s9p2vavMrwyz6YrEQ+a0bEPBUI
Fj271S88/d8RPjg9kr7YeBA+qZ0EpqdP7D091Ag9EkQPPiU8dL3xPlm96iXJPb
GRBL5YsBc+gSKWPQHnzr0Lhus7at0MvgE7Bj6wyEE99oAUvu34CL2QT849hlNA
vnlTvb3XdEQ9hHQXvm5VOb7gVXy+cj7rPWUswj7O11E+0jQXvhefQjxk8co8v9
i4PEi09z1qwQQ+qeGTvCCC47zOcYm9m8t5PWRZuz4dwKi8lsavvesvUj731mO9
0h/4Paz8TTx4B5k7P++CvWIqIr1Tnbi9q2MuPJnpJT19w4+99uW2vOQp7T0ZkR
q+T15DPgq+WL1rD7k8QSzYPCExy7zSAwS+3+MrPLyCJj7TqYS+nA2UPYhZPD76
YRQ9v1sGPj86gT1Oar+899isPH3wNL3+RVW+ovKzvYqzHj2wYQ09Ib+GO75BKD
w=

By comparison with the exemplary data set above, a compressed first data set comprising 1-byte integers in Base64 encoding as float may appear for example as follows. The data volume and thus the required storage space are reduced, by a factor of 4, to 172 characters:

Z3KLbWV1em2RWKZuTWx8gGFUa1Z2h2t8SCdcVn9db5NicICWYWadgVeDb9Sje3
54lzCXlJF9lmdojFaYh113VJSAUm2NSF+AUUo6kNCmUnh3epKUcW5lhKZwYKZo
fHh2Zmtfd39kcJFRo2h6e29Wd5w3hqF+lIRvempDY359dnc=

The use of the reduced, scaled integers advantageously does not result in a significant reduction in the accuracy of the identification of correspondence between two data sets based on biometric characteristics 2 and/or second biometric characteristics 2, for example for the purposes of document verification, in relation to the use of the original floating point numbers. The overall accuracy of the method according to the invention is preferably at least 95%, more preferably at least 97.5%, even more preferably at least 98.9%, in particular in relation to a method involving an uncompressed first data set.

The positive accuracy is preferably at least 80%, more preferably at least 90%, even more preferably at least 98.2%. The negative accuracy is preferably at most 2%, more preferably at most 1%, even more preferably at most 0.5%.

In step d), useful data are provided in at least one second data set. The second data set is added to the first data set. In particular, after the addition, the first data set comprises the at least one second data set. Step d) is preferably carried out after step c) and before step e).

The useful data may comprise or be data which specify the document 4 in which the code 3 is arranged and/or specify a person to which the document 4 has been issued. An exemplary document 4 is shown in FIG. 4.

It is possible that the useful data and/or the second data set contain document data selected from the group consisting of personal data, document type, issuing country, issuing authority, signer identifier, certification number, series number, check number, image data, document issue date, hand signature date, validity duration, machine-readable zone (MRZ), URL (Uniform Resource Locator), or combinations thereof.

It is possible that the useful data and/or the second data set contain one or more personal data 5 selected from the group consisting of name, nationality, gender, eye color, height, hand signature, date of birth, place of birth or combinations thereof.

In step e), a first hash value of the compressed first data set or of the compressed first data set and the second data set is generated. Step e) is preferably carried out after step d) and before step f).

The one or more data sets that are input into the hash function to create the hash value may preferably be based on biometric characteristics 2 and/or useful data, and may more preferably comprise at least the compressed first data set.

An SHA-1 function or an SHA-2 function, preferably an SHA-256 function, or an SHA-3 function is preferably provided as a hash function. In particular, an SHA-256 function is provided. A 256-bit hash value is preferably obtained as a hash value, in particular the first hash value and/or the second hash value. The hash value, in particular the first hash value and/or the second hash value, is preferably a hexadecimal number with 64 digits.

In step f), a signature is generated for the first hash value that was obtained in step e). Step f) is preferably carried out after step e) and before step g).

It is possible that the signature algorithm uses an Elliptic Curve Digital Signature Algorithm (ECDSA).

A signature, preferably an ECDSA 256-bit signature, more preferably when using the SHA-256 function, in particular using the brainpool256r1 curve, preferably has a size of 64 bytes.

In step g), a code 3 is obtained which is based on the compressed first data set. The code 3 therefore makes it possible for the biometric information items 1 and/or biometric characteristics 2 extracted in step b) to be retrieved, evaluated and verified. Step g) is preferably carried out after step f).

The code 3 is preferably in the form of a geometrical and graphical pattern. It is possible for the code 3 to be generated as a machine-readable 2D code, preferably a matrix code, QR code, Micro QR code, DataMatrix code, MaxiCode, Aztec code, JAB code, Han Xin code, a DotCode, a stacked code, preferably Codablock, Code 49, PDF417, or a combination thereof. The 2D code may preferably be combined with a 1D code. The code 3 is in particular not a 1D code and/or not human-readable.

The code 3 preferably has a dimension of 20 mm×20 mm. The code 3 preferably has 80 modules×80 modules. It is possible that the code 3 exhibits error correction.

The code 3 comprises at least the compressed first data set or additionally the second data set with the useful data, comprises the first hash value of the compressed first data set or additionally also of the second data set with the useful data, comprises a signature, preferably comprises a header, and preferably comprises error correction. It is possible that the header is part of the useful data. It is thus possible that the header is comprised by the hash value, in particular by the first and/or second hash value. It is possible that the error correction is not comprised by the hash value, in particular by the first and/or second hash value.

The code 3 may preferably comprise a data volume selected from the range from 1 byte to 520 bytes, preferably from 32 bytes to 412 bytes. In particular, the data volume comprises at least the compressed first data set, the first hash value, the signature and optionally the header.

It is possible that the code 3, in particular before it is arranged on a document 4, is embedded into a two-dimensional discrete complex function G(fx, fy) having an fx frequency coordinate and an fy frequency coordinate, and the two-dimensional discrete complex function G(fx, fy) is Fourier-transformed and is binarized to form a two-dimensional image. The two-dimensional image obtained is arranged on the document 4. A method for verifying such a code 3 has a further step for retransformation, which is carried out before the compressed first data set is read out from the code 3.

It is possible that the code 3 is arranged on or in a document 4. The code 3 is preferably configured such that it can be arranged and/or used in a document 4.

It is possible that the code 3 exists and/or is used in digital form, for example as a PDF or as an image file. The code 3 may exist and/or be used in digital form on a device of an end user, preferably smartphone and/or tablet and/or computer. It is alternatively possible that the code 3 exists or is used as embossment and/or as a printed layer.

FIG. 4 shows an exemplary document 4 on which the code 3 is arranged. The document also has further personal data 5 and security elements 6.

It is possible that the document 4 is, or is provided as, a certificate, deed, ticket, preferably flight ticket, rail ticket, event ticket, concert ticket, conference ticket, entry ticket, an access control document, or an official document, preferably visa, residence permit, proof of arrival, temporary identity document, residence title.

The personal data 5 shown in the document 4 according to FIG. 4 may be selected from the group consisting of name, nationality, gender, photograph, hand signature, date of birth or combinations thereof. The personal data 5 are in particular human-readable and machine-readable.

It is possible that the document 4 comprises the useful data, which are comprised by the code 3, in human-readable and/or machine-readable form. It is possible that the document 4 is provided and/or exists in digital form, preferably as a PDF or as an image file, or in physical form.

If the document 4 exists in physical form, it is possible that the document 4 has one or more security elements 6 selected from the group consisting of security print, metal layer, RFID chip, optically variable security element, machine-readable element or combinations thereof.

The optically variable security element preferably has an optically active relief structure selected from the group consisting of diffraction grating, hologram, zeroth-order diffraction structure, blaze grating, macrostructure, in particular lens structure or microprism structure, mirror surface, matte structure, in particular anisotropic or isotropic matte structure. It is possible that the optically variable security element has elements selected individually or in combination from the group consisting of metallic reflection layer, high-refractive-index (HRI) reflection layer, volume hologram, thin-film structure with color change effect, in particular Fabry-Pérot three-layer thin-film structure, liquid crystal material, preferably nematic or cholesteric liquid crystal material, dyes and/or pigments, preferably phosphorescent pigments, luminescent pigments, thermochromic pigments and/or optically variable pigments.

Alternatively, the document 4, in particular if it exists in digital form, may have at least one or more security elements 6 selected from the group consisting of digital watermark, electronic and/or digital signatures, asymmetric and/or symmetric encryptions, digital hand signatures, password protection or combinations thereof.

The code 3 may partially or fully overlap, or be partially or fully overlapped by, a security element 6, in particular in a view directed perpendicularly onto the plane spanned by the document 4. It is possible that the code 3 is partially or fully comprised by a decorative element of the document. The code 3 may partially or fully overlap, or be partially or fully overlapped by, the decorative element.

FIG. 2 is a schematic illustration of a sequence of a method for verifying a code 3, in particular the code 3 according to the method shown in FIG. 1, wherein the code 3 has a first data set based on first biometric characteristics 2′.

The method shown in FIG. 2 has at least one of the following steps A) or B):
A) creating a compressed third data set, wherein the compressed third data set is based on second biometric characteristics 2″, wherein step A) comprises at least the following sub-steps:
   capturing at least one biometric information item 1 of a real person, a photograph or a video,
   extracting second biometric characteristics 2″, in particular by means of a neural network, from the at least one biometric information item 1 in the form of a third data set,
   compressing the third data set to obtain a compressed third data set, or
B) opening a database which comprises at least one compressed third data set, wherein the compressed third data set is based on second biometric characteristics 2″.

The method shown in FIG. 2 also has at least the following steps:
h) reading out a compressed first data set from the code 3, wherein the compressed first data set is based on first biometric characteristics 2′, and comparing the compressed first data set with the compressed third data set,
i) generating an evaluation parameter that allows the evaluation of a correspondence of the compressed first data set with the compressed third data set,
j) outputting an evaluation on the basis of the generated evaluation parameter.

The method according to FIG. 2, in particular one, two or more steps of the method, for verifying the code 3 may be carried out on an external server and/or carried out locally on a device. It is possible that the device has no network connection. In particular, the method is configured for verifying the code 3 according to the invention.

It is preferably possible for one, two or more steps of the method for verifying the code 3 to be executed on a device which is selected from the group consisting of smartphone, camera, tablet, PC, terminal, IoT devices or combinations thereof. The device has at least one apparatus for capturing images, and has a processor for carrying out at least one further step of the method.

In step A), a compressed third data set is created, wherein the compressed third data set is based on second biometric characteristics 2″. Data transmitted to or created by the server, the client device or the device are optionally checked in step A). In particular, the image quality, the orientation, the detail and/or the presence of adequate lighting may be checked.

In particular, it is possible that, in step A), at least the following points are checked on the server, on the client device or on the device:
checking whether at least one biometric information item 1 is present,
checking whether a single biometric information item 1 or two or more biometric information items 1 is or are present,
checking whether the at least one biometric information item 1 is present with dimensions selected from the range of at least 100×100 pixels, preferably at least 80×80 pixels.

It is possible that the orientation of the biometric information item 1 is optionally checked on the server, on the client device or on the device. Here, the orientation is checked in respect of an x direction, a y direction and a z direction, wherein, in particular, the roll-pitch-yaw angles are used.

The yaw angle is preferably selected from the range from 324° to 36°, more preferably from 336° to 24°, even more preferably from 348° to 12°. In other words, the deviation from 0° is preferably up to 36°, more preferably up to 24°, even more

1. A method for generating a code based on biometric characteristics,
wherein the method comprises at least the following steps:
a) capturing at least one biometric information item from a real person, a photograph and/or a video,
b) extracting first biometric characteristics from the at least one biometric information item in the form of a first data set,
c) compressing the first data set to obtain a compressed first data set,
d) adding a second data set comprising useful data to the compressed first data set,
e) generating a first hash value of the compressed first data set or of the compressed first data set and the second data set,
f) generating a signature for the first hash value,
g) generating the code in the form of a geometrical pattern comprising the first compressed data set, which is based on the first biometric characteristics, and comprising the first hash value and the signature.

2. The method according to claim 1, wherein
a quantization method is used for the compression in step c).

3. The method according to claim 1, wherein embedding numbers are used for the compression in step c).

4. The method according to claim 1, wherein step c) comprises the following two sub-steps:
calculating an embedding width by means of the embedding numbers,
quantizing a 4-byte floating point number of the first data set by means of the embedding width and the embedding numbers, to obtain a 1-byte integer.

5. The method according to claim 4, wherein
that sub-step of step c) in which the 4-byte floating point number is quantized is described as follows:
subtracting the lowest embedding number from the 4-byte floating point number, wherein the result is divided by the embedding width, with a value in the 4-byte format within the embedding range being obtained,
dividing the previously obtained result by the 4-byte floating point number,
multiplying the previous result by the number of possible embedding values,
rounding the previous result to the next whole number, with a 1-byte integer being obtained.

6. The method according to claim 1, wherein at the start of step c), the first data set is an array of 128 floating point numbers, wherein each floating point number comprises 4 bytes, and the compressed first data set is an array of 128 integers, wherein each integer comprises 1 byte.

7. The method according to claim 1, wherein the size of the compressed first data set in step c) is reduced by a factor of 4 in relation to the first data set.

8. (canceled)

9. The method according to claim 1, wherein the at least one biometric information item is captured by means of a device selected from the group: smartphone, camera, tablet, PC, terminal, IoT devices or combinations thereof.

10. The method according to claim 9, wherein
the device is a client device, and the at least one biometric information item is transmitted via a network to an external server, on which one or more or all of the subsequent steps are carried out.

11. The method according to claim 9, wherein
all of the steps of the method are carried out locally on the device.

12. The method according to claim 1, wherein the number of first biometric characteristics is selected from the range from 50 to 200.

13. The method according to claim 1, wherein the first biometric characteristics are described as vectors and/or as coordinates in a coordinate system, as a type or class, as binary data points, and/or as a combination thereof.

14. The method according to claim 1, wherein step b) for extracting the first biometric characteristics comprises at least the following sub-steps:
identifying and specifying a first region that is used for the extraction,
identifying the first biometric characteristics in the first region,
extracting the first biometric characteristics in the first region.

15. (canceled)

16. (canceled)

17. The method according to claim 1, wherein the useful data contain document data selected from the group consisting of personal data, document type, issuing country, issuing authority, signer identifier, certification number, series number, check number, image data, document issue date, hand signature date, validity duration, machine-readable zone, URL, or combinations thereof,
and/or wherein the useful data and/or the second data set contain one or more personal data selected from the group consisting of name, nationality, gender, eye color, height, hand signature, date of birth, place of birth or combinations thereof.

18. The method according to claim 1, wherein the first hash value is obtained by means of a hash function, wherein an SHA-1 function or an SHA-2 function or an SHA-3 function is provided as a hash function.

19. The method according to claim 1, wherein step e) comprises the following sub-steps:
e1) providing at least the compressed first data set, and providing the hash function,
e2) inputting at least the compressed first data set into the hash function,
e3) calculating the first hash value from at least the first compressed data set,
e4) outputting the first hash value.

20. The method according to claim 1, wherein the signature is generated by means of an elliptic curve digital signature algorithm.

21. The method according to claim 1, wherein the code is provided as a machine-readable 2D code.

22. The method according to claim 1, wherein the code comprises a data volume selected from the range from 1 byte to 520 bytes.

23. The method according to claim 1, wherein the code is embedded into a two-dimensional discrete complex function G(fx, fy) having an fx frequency coordinate and an fy frequency coordinate, and the two-dimensional discrete complex function G(fx, fy) is Fourier-transformed and is binarized to form a two-dimensional image.

24. (canceled)

25. A method for verifying a code wherein the method comprises at least the following steps A) or B):
A) creating a compressed third data set, wherein the compressed third data set is based on second biometric characteristics, wherein step A) comprises at least the following sub-steps:
capturing at least one biometric information item of a real person, a photograph or a video,
extracting second biometric characteristics from the at least one biometric information item in the form of a third data set,
compressing the third data set to obtain a compressed third data set, or
B) opening a database which comprises at least one compressed third data set, wherein the compressed third data set is based on second biometric characteristics,
wherein the method also comprises at least the following steps:
h) reading out a compressed first data set from the code, wherein the compressed first data set is based on first biometric characteristics, and comparing the compressed first data set with the compressed third data set,
i) generating an evaluation parameter that allows the evaluation of a correspondence of the compressed first data set with the compressed third data set,
j) outputting an evaluation on the basis of the generated evaluation parameter.

26. The method according to claim 25, wherein the method comprises step A) and,
in step A), at least the following points are checked on the server, on the client device or on the device:
checking whether at least one biometric information item is present,
checking whether a single biometric information item or two or more biometric information items is or are present,
checking whether the at least one biometric information item is present with dimensions selected from the range of at least 100×100 pixels.

27. The method according to claim 25, wherein the orientation of the at least one biometric information item is checked on the server, on the client device or on the device.

28. (canceled)

29. The method according to claim 25, wherein the method comprises step A) and, in step A), the second biometric characteristics are extracted by means of a neural network.

30. The method according to claim 25, wherein the evaluation parameter is a distance between the compressed first and compressed third data set.

31. The method according to claim 25, wherein the method comprises the further step:
checking the validity of the signature.

32. A document which comprises a code generated according to claim 1.

33. The document according to claim 32, wherein
the document exists in digital form or in physical form.

34. (canceled)

35. The document according to claim 32, wherein the document comprises one or more personal data selected from the group consisting of name, nationality, gender, eye color, height, photograph, hand signature, date of birth, place of birth or combinations thereof.

36. The document according to claim 32, wherein the document comprises the useful data, which are comprised by the code, in human-readable and/or machine-readable form.

37. The document according to claim 32, wherein the document, if it exists in physical form, has one or more security elements selected from the group consisting of security print, metal layer, RFID chip, optically variable security element, machine-readable element or combinations thereof,
or
wherein the document, if it exists in digital form, has at least one or more security elements selected from the group consisting of digital watermark, electronic and/or digital signatures, asymmetric and/or symmetric encryptions, digital hand signatures, password protection or combinations thereof.

38. The document according to claim 32, wherein the document has an optically variable security element, wherein the optically variable security element has an optically active relief structure selected from the group consisting of diffraction grating, hologram, zeroth-order diffraction structure, blaze grating, macrostructure, mirror surface, matte structure,
and/or
wherein the optically variable security element has elements selected individually or in combination from the group consisting of metallic reflection layer, high-refractive-index reflection layer, volume hologram, thin-film structure with color change effect, dyes and/or pigments.

39. The document according to claim 32, wherein the code partially or fully overlaps, or is partially or fully overlapped by, a security element, and/or wherein the code is partially or fully comprised by a decorative element.

40. (canceled)
